(19) United States
(12) Patent Application Publication
(10) Pub. No.: US 2004/0080529 A1
(43) Pub. Date: Apr. 29, 2004

(54) Method and system for securing text-entry in a web form over a computer network

(76) Inventor: Paul Kazimierz Wojcik, Mississauga (CA)

Correspondence Address: Paul Wojcik, 3236 Mainsail Cres, Toronto, ON, LSL 1M2, CA

(21) Appl. No.: 10/278,541

(22) Filed: Oct. 24, 2002

(51) Int. Cl. G09G 5/00

(52) U.S. Cl. 345/738

(57) ABSTRACT

The present invention relates to communications network security and, more particularly, to a method and system for providing secure text entry in web forms.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The need to control access to web-based information and services to selected authorized users, has resulted in broad adoption of HTML form-based authentication process. This process involves a web service provider delivering an HTML login-form to a user's web browser and then requiring a user to type-in the credentials (such as userid and password) associated with his/her account. The user submits this information to the web service provider via the web browser, and only after successful verification of the account information at the service provider, can the user gain access the service or information.

Typically, the service or information provided to the user is sensitive and private, as is the case for example with web-based email services, or Internet banking and investment services. To protect the privacy of this information, service providers typically use a security protocol such as Secure Socket Layer (SSL) to keep user information encrypted as it is transported across a computer network (such as the internet): from the service provider computer to the user's computer, and back. Although SSL is very good at protecting the privacy and integrity of user information as it is transported across the Internet, it does not address other security weaknesses in HTML form-based authentication.

One major security weakness of such user authentication systems, is that a service provider has no way of knowing if the person who provides valid userid and password credentials, is actually the authorized owner of the account. For example, the person providing valid credentials could very easily be someone who has stolen these credentials from the authorized owner. Consequently, the confidentiality and security of virtually all such systems are completely defeated if a valid userid and password is discovered by a third party.

This threat has generally been addressed by advising users to take precautions such as (a) selecting difficult-to-guess passwords, or (b) not using the same password with other service providers, and (c) changing passwords regularly. Even these steps however are inadequate, considering how easy it is for an unauthorized third party (an “identity thief”) to steal private passwords using simple software called “keyloggers”.

A keylogger is a type of software that surreptitiously captures all keystrokes typed into a user's computer via the hardware keyboard. This information is usually stored in a hidden file on the user's computer, and is later scanned by the identity thief to discover userids and passwords. Keyloggers perform their work unobtrusively and so are very difficult to detect by an unsuspecting user. In order to do their work, keylogging software must first be installed and executed on the user's computer by the identity thief. This is not as difficult an obstacle as might appear at first. For instance, it is a relatively simple task for an identity thief to install a keylogger on publicly accessible computers at Internet cafes, and to return periodically to scan the log of keystrokes to discover passwords and userids. For this reason, users who access their private information on the Internet from publicly accessible computers are particularly vulnerable to having their online identities stolen.

Employees at work are vulnerable to keyloggers that can be remotely installed on their computers over the company's network by, for example, a system administrator or support technician, or co-worker. In fact, some companies have an explicit policy to install keyloggers on company computers, in order to monitor employees' use of computer equipment and resources. Furthermore, anyone who has physical access to the employee's computer—even for a brief interval—can potentially install a keylogger without the knowledge of the employee. There have also been reported instances of keyloggers being stealthily installed on user computers by software viruses delivered through email.

Prior art known to address this problem include physical devices that are coupled with the physical keyboard, which encrypt keystrokes before they are transmitted to the computer. One problem with this approach is the very fact that it is a physical device, which limits its usefulness as a general tool that can be delivered by a service provider to enhance security.

There is also much prior art describing methods to protect the confidentiality of passwords as they are transferred across a computer network. But this prior art does not solve the problem of securing the act of entering passwords on the user computer, before they are transferred over a network. There is also prior art that addresses the problem indirectly, by endeavoring to make a user's passwords more memorable, by forgoing text-based passwords entirely and instead using various visual pattern recognition protocols. However, these solutions do not integrate very easily with the vast majority of web authentication schemes which rely on text-based passwords.

Prior art also includes general-purpose graphical keyboards which are incorporated in to a computer operating system and can be used to enter text via a pointing device, but these general purpose graphical keyboards are not designed to solve the security problem addressed by the present invention. Most importantly, general purpose graphical keyboards are not secure, since any text entered with such a device first must be copied in to a common memory space (known as a “clipboard”) before it can be entered in to a web form. This common memory space is by its nature available to all other programs executing on the user's computer, and so it would be an easy task for a keylogger or any other application to discover passwords entered this way.

A preferred embodiment of the present invention addresses this security problem by providing an immediately accessible method as part of the processes of presenting a web form on a web page, by which a user can securely enter text.

Reference:

Identity Theft: The Crime of the New Millennium, Sean B. Hoar, United States Attorneys' U.S.A. Bulletin, March 2001 Vol. 49, No. 2

### BRIEF SUMMARY OF THE INVENTION

A method and system is described which enables secure entry of text information in to a web form using a web browser on a computer network. In a preferred embodiment of the present invention, a script-based graphical keyboard module (“graphical keyboard”) delivered as part of a web login-page, provides the capability to enter userid and password information in a manner that is not vulnerable to interception by keystroke-detecting software (“keyloggers”) executing surreptitiously on a user's computer. A graphical keyboard is comprised of a graphic display module, which contains multiple user-selectable areas (“virtual keys”), each of which displays a unique symbol (“virtual key character”). Virtual key characters can be randomly assigned to virtual keys on a graphical keyboard, and so do not necessarily correspond to the layout of similar keys on a hardware keyboard. Virtual key characters can also be randomly repositioned on the graphical keyboard at the initiation of a user, or at intervals determined programmatically. A user selects a virtual key using a pointing device, and the virtual key character assigned to the virtual key is automatically entered in to the active text-entry field of a web form on a web page. The graphical keyboard does not disable the hardware keyboard, but acts as an alternate method of text-entry for a web form for as long as the web form is visible.

Since the present invention provides a mechanism to circumvent the physical keyboard to enter text in to a web form, keylogging software cannot detect any of the characters that have been entered to the web form using this method. In addition to keystroke detection, sophisticated keyloggers are also designed to capture screen cursor movements and selections; but the random characteristics of the present invention also defeats any attempts to use screen cursor movement information to discover characters entered in to a web form.

The present invention improves on prior art by defining a method to present a graphical keyboard as an integral part of delivering a web form in a web page to a web browser, thus enabling the web service provider to guarantee that a user has, at their immediate disposal, a mechanism to securely enter text into a web form.

### BRIEF DESCRIPTION OF THE DRAWINGS

FIG. 1 is a flow diagram illustrating a method of securing text entry in a web form according to an embodiment of the invention.

FIG. 2 is a block diagram illustrating components in a graphical keyboard module according to an embodiment of the present invention.

FIG. 3 is a listing of sample HTML web page and graphical keyboard implementation according to an embodiment of the invention.

FIG. 4 is a listing of sample HTML and Javascript code of a graphical keyboard implementation according to an embodiment of the invention.

FIG. 5 is a listing of sample HTML and Javascript code of a graphical keyboard implementation according to an embodiment of the invention.

FIG. 6 is a block diagram of a communications network with web server and web client

### DETAILED DESCRIPTION OF THE INVENTION

The present invention provides a method and system for securely entering text into web forms accessed via web browsers over a computer network. In the following description, many specific details are given in order to provide a more complete description of the invention. However, It will be apparent to one skilled in the art, that the invention may be applied without these specific details. Conversely, many features well known to those skilled in the art, have not been described in detail in order to not obscure the invention.

Components of the System

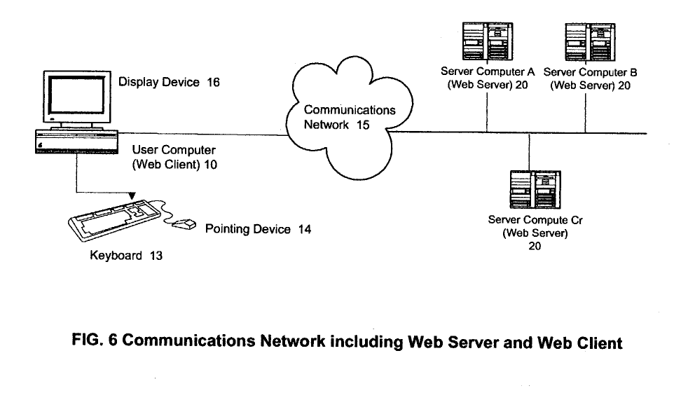

Referring to FIG. 6, a communications network includes a plurality of computer nodes, including at least one user computer (10) and one or more server computers (20), interconnected by a communications medium (15). In general, each of the computer nodes contains memory for storing instructions and data structures contained in operating system software and in software associated with delivering and rendering web content, as described herein. Examples of operating system software include but are not limited to WindowsXP, OSX, Linux, Solaris and the like. In addition, computer nodes contain one or more CPUs for executing instructions stored in memory. Computer nodes also contain a display device (16) such as a CRT monitor, and a hardware keyboard (13) for text-entry. User computers generally also contain a pointing device (14) such as a mouse, in order to make selections on the display device.

In addition to operating system software, a user computer contains web browser software, which sends requests to the server computer via the communications medium, using “Hypertext Transfer Protocol” (HTTP). Web browser software retrieves web content that is returned in response to each HTTP request, and further renders or executes said web content. Web content includes, but is not limited to HTML text, images, video, audio, scripts, executable modules and the like. Examples of web browser software include “Internet Explorer” from Microsoft Corporation and “Mozilla browser” from Mozilla.org.

Typically, a server computer contains web server software such as Microsoft Internet Information Server (IIS) or Apache Web Server. Web server software accepts HTTP requests over a communications network from a web browser executing on a user computer. In reply to each HTTP request, a web server sends web content, such as an HTML-formatted document (web page) to the web browser on said user computer.

A preferred embodiment of the present invention describes a method and system for securely entering text in a web login form during web-based user authentication. Web-based authentication refers to the process of validating user credentials submitted via an HTTP request. Typically, such an HTTP request is the result of a user submitting values from a web form using a web browser. More specifically, when a user wishes to access a web server computer, the user directs the web browser software to retrieve a web login page by, for example, typing the URL address of the web server computer into the web browser. In response, the web server delivers to the user's web browser, a web login page which contains an HTML login form (web login form). The web login form typically contains at least a “user name” and “password” text-entry field, as well as a button to submit these values to the web server. After entering a “user name” and “password” in to the respective text-entry fields, a user selects the submit button on the web login form, and the web browser software sends these values (user credentials) to the web server for validation, using an HTTP request. The web server then validates these credentials against a database and upon success, the user is allowed to access other documents on the web server. If the credentials are invalid, the user is not allowed access to documents on the web server, and typically a web server will respond by sending another web login page to the user's web browser so that valid credentials can be entered.

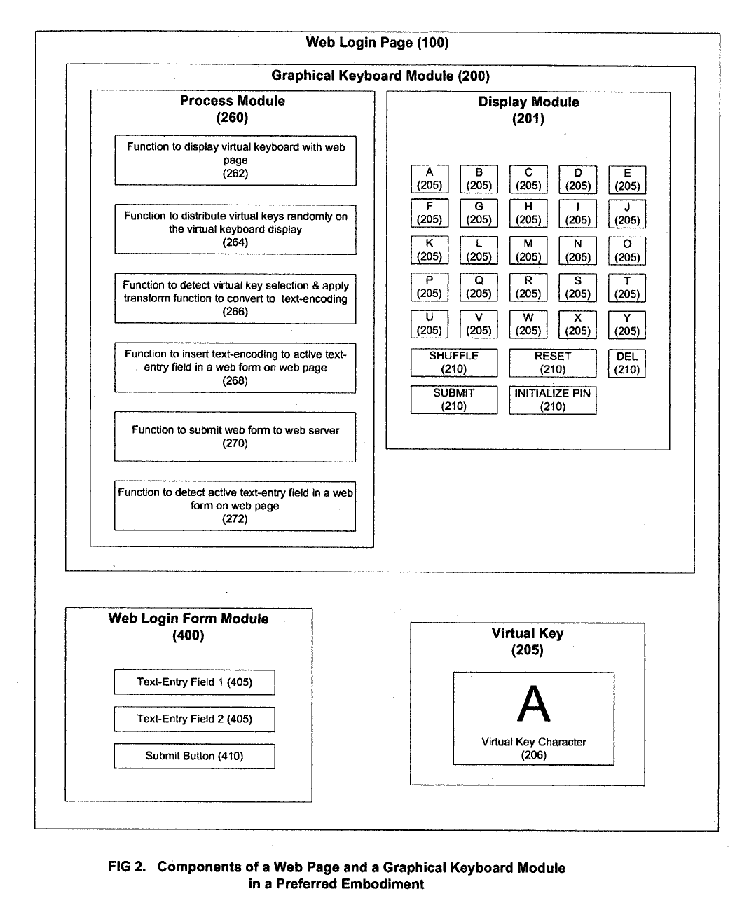

Now referring to FIG. 2, a web login page (100) contains a login form module (400) and a graphical keyboard module (200). In one embodiment of the invention, a login form module (400) is comprised of an HTML form object, which contains one or more HTML text-entry form elements (such as for entering userid and password), and a submit button. A graphical keyboard module (200) contains a display module (201), and a process module (260). A display module (201) represents a visible area on a web login page (100), and is comprised of a plurality of virtual keys (205) which are visible, discreet areas on the display module that can be individually selected by a user with a pointing device. In an embodiment of the invention, virtual keys (205) are displayed in an orderly matrix of rows and columns designed to resemble a layout of physical keys on a hardware keyboard. Each of said virtual keys (205) displays a virtual key character (206) which is typically a symbol that can be found on one of the hardware keys on the hardware keyboard. In one embodiment of the invention, virtual key characters (206) are assigned randomly to virtual keys (205), so that the location of a particular virtual key character (206) does not correspond to the location of the same character on a hardware keyboard.

A display module (201) also contains virtual function keys (210) which do not display a virtual key character (206), but rather, perform a function on the graphical keyboard module (200) itself One of these virtual function keys is the SHUFFLE function key, which, when selected by a user, causes all virtual key characters (206) to be randomly reassigned to the virtual keys (205). Other virtual function keys include DELETE (which removes a character at the active text cursor from a text-entry field in a login form); and RESET which reassigns each virtual key character (206) to it's initial virtual key (205); INITIALIZE PIN which enables a user to enter a personal number to initialize the graphical keyboard's transformation function (described below).

In a preferred embodiment of the invention, a graphical keyboard module (200) is implemented with an HTML form object and Javascript code. The HTML form object serves as a graphical keyboard display module (201), and contains multiple HTML button elements which function as virtual keys (205). Javascript code implements methods of the graphical keyboard process module (260) as described below. Each of the HTML button elements contains a “name” property, which defines text that is displayed to a user in association with the HTML button, and in the preferred embodiment, is assigned the character encoding representing the virtual key character (206) itself In addition, each of the HTML button elements defines a Javascript “onClick” event handler, which is used to detect the selection of a virtual key character (206).

A graphical keyboard process module (260) contains functions which interact with both the graphical keyboard display module (201) and the login form module (400). In a preferred embodiment the graphical keyboard process module (260) is implemented with Javascript code. These functions are described in detail below, and include: (a) a function which positions virtual keys on a graphical keyboard display module; (b) a function which assigns virtual key characters to virtual keys; (c) a function which detects a virtual key selection on a display module (d) a function which converts a virtual key selection to a text-encoding according to a transformation function (e) a function which determines the active text-entry field in a login form module (f) a function which adds and removes characters on text-entry fields of a login form module.

Method of Securing Text Entry in Web Forms

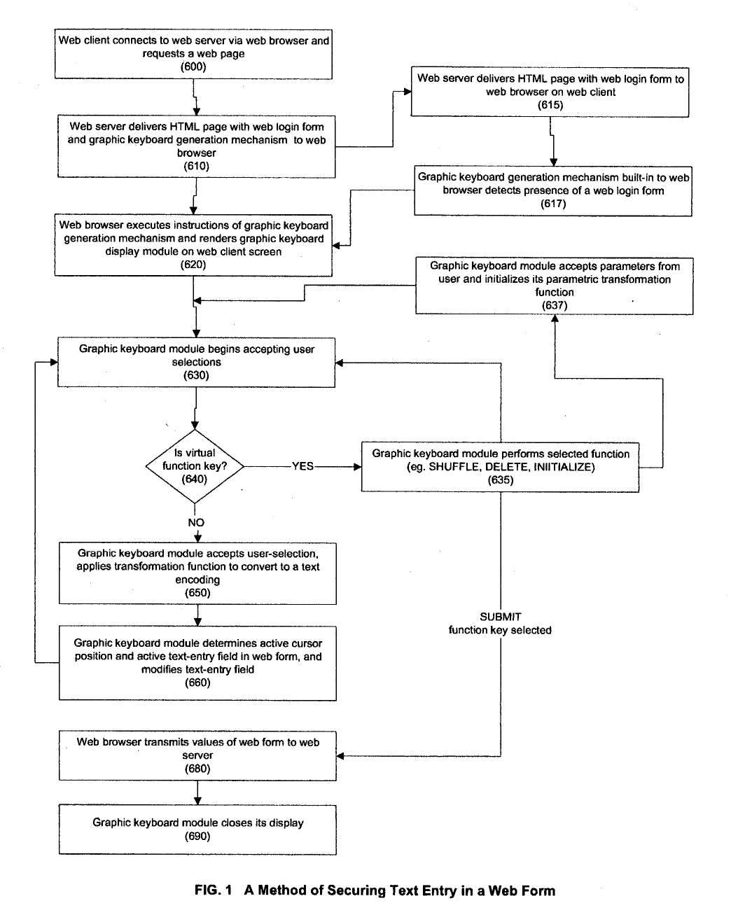

Now referring to FIG. 1, which outlines a method of securing text entry in web forms, beginning with step 600 wherein a web client connects to a web server using a web browser over a communications network, and requests a web page. Proceeding to step 610, said web server delivers a document formatted in HTML code (web page) to the web browser, and in a preferred embodiment, said web page contains an HTML-based web login form. In a preferred embodiment, said web page further contains a graphic keyboard generation mechanism, which in one implementation consists of HTML and Javascript code.

Now proceeding to step 620, wherein a web browser executes instructions of the graphic keyboard generation mechanism upon receipt of said web page, resulting in a graphic keyboard being displayed on the web client. The graphic keyboard display may be shown embedded within the contents of the web page itself, or alternatively, it may be shown in a new window region in front of said web page, in a manner which does not obscure the web login form contained in said web page.

In an alternate embodiment of the present invention, a graphic keyboard generation mechanism is not delivered with the web page, but rather is incorporated in the logic and programmatic code of the browser mechanism on the web client. In such an embodiment, a web server simply delivers a web page with a web login form (615) to a web client, and said graphic keyboard generation mechanism embedded in the web browser, detects the presence of said web login form (617) by scanning the content of said web page. Upon detecting said web login form, the graphic keyboard generation mechanism is then disposed to render a graphic keyboard display (620). The graphic keyboard display may be shown immediately, or at the initiation of the user by for example, selecting a button on the web browser, or pressing a sequence of hardware keys (hot key).

Once a graphic keyboard display is made visible on a web client, the graphic keyboard module begins accepting user input (630) via a pointing device, such as a mouse. When a user makes a selection on the graphic keyboard display, the graphic keyboard process module determines if the selection is a virtual key, or a virtual function key (640). If the selection is a virtual key, the graphic keyboard process module determines the virtual key character assigned to the selected virtual key, and applies a transformation function to convert the virtual key character to a character encoding (650) suitable for inserting in to a text-entry field of a web form. The transformation function is configured to provide a character encoding which matches the text encoding specified within the HTML code of the web page containing the web form (for example, “Unicode”, “UTF8”, “SHIFT-JIS” and the like). In a preferred embodiment, the transformation function simply returns a character encoding which represents the same virtual key character.

In another embodiment, a transformation function returns a character encoding which represents a character entirely different from the virtual key character which is displayed on the virtual key. In such an embodiment, the transformation function may be implemented using any type of parametric algorithm, such as for example a pseudo-random number generator which is initialized with a seed. Typically, parameters to this function (such as the random seed, or PIN number) will be supplied by a user by, for example, selecting virtual keys on the graphical keyboard display (635 and 637). One application for this type of transformation function is to increase the strength of user passwords, particularly for users who tend to reuse the same simple password across different domains. For example, in one embodiment, a transformation function is a pseudo-random number generator which is seeded with a number returned by a function combining a PIN number (e.g. 8239) entered by a user and the URL address of the web site the web page was loaded from (e.g. www.mydomain.com). In such a system, a user entering a simple password (e.g. “password”) on a graphical keyboard display of the present invention, would result in a much more cryptic password (e.g. “SgY(*^{A}dF&KcL45”) being automatically entered into the text-entry field of the web login form. A user would simply need to remember a simple password and simple PIN number to automatically enjoy the benefit of stronger passwords. Furthermore, the inclusion of one or more parameters which varies between web sites (e.g. web site address) results in entirely different text encoding returned by such a parametric function for each web site, which results in unique cryptic passwords for each web site. This enables a user to employ the same simple password and PIN number across multiple web sites more securely, that is, with less worry that a cryptic password discovered at one web site, can be used to access another web site (even though the same simple password was used for both domains with this system).

Once a virtual key character has been converted to a text encoding using the transformation function (650) by the graphical keyboard process module, the system proceeds to step 660 which involves determining which of the text-entry fields in the web form to modify, and at which cursor position to insert the new text encoding. In a preferred embodiment, the graphic keyboard process module modifies the text-entry field which has the active text cursor in the web login form, and simply appends to the end of the text in the text-entry field. Determining which text-entry field is active, is accomplished by listening to “onFocus” events generated by a web login form as described below.

Now proceeding to step 680, wherein the values of a web login form a transferred to the web server using HTTP protocol over a communications network (such as the Internet), by a web browser. This step is initiated by a user selecting a submit button on a web login form, or by selecting a submit button on a graphical keyboard display module. In the latter case with a preferred embodiment, the graphical keyboard process module uses Javascript code to invoke the submit( ) method of the HTML form object. Once the web form values are submitted, a graphical keyboard display module is closed (690) either by the graphical keyboard process module itself, or by the web browser in the process loading and displaying a subsequent web page.

Components of a Graphical Keyboard Process Module

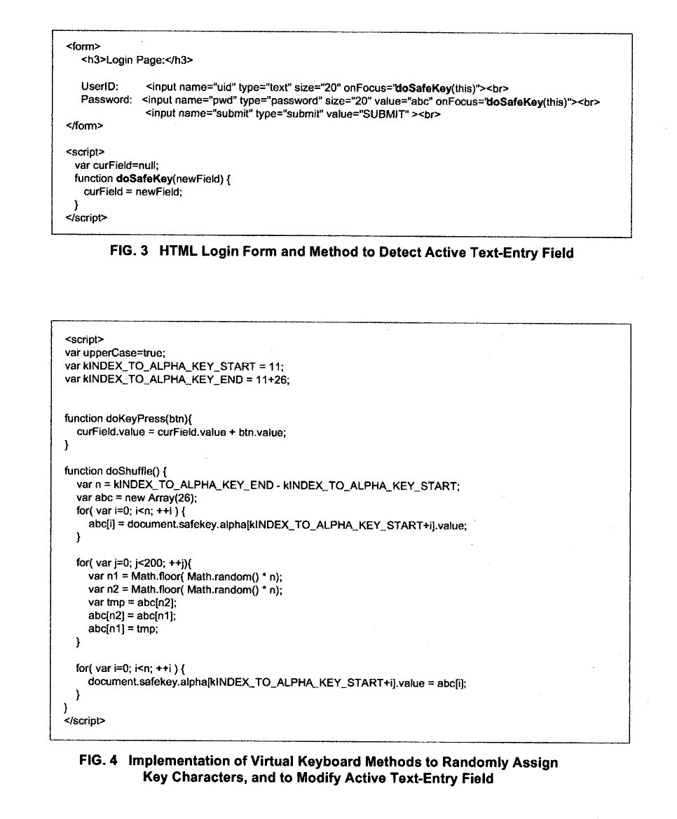

Now proceeding to describe the components of a graphical keyboard process module (260). A process module (260) includes a function (272) which enables detection of the active text entry field in a web login form module (400). An active text entry field is one which has the cursor focus, and which therefore accepts and displays characters typed by a user. Referring to FIG. 3, an implementation of this method is shown as it exists in a preferred embodiment. A Javascript method “doSafeKey( )” is defined which accepts an HTML text field object as an argument, and stores a reference to this object in global storage. Still referring to FIG. 3, a sample HTML login form is shown wherein a userid and password text-entry field declarations include a reference to the “doSafeKey( )” method as the “onFocus” event handler. The onFocus event handler is part of the HTML language specification and works as follows: Whenever an HTML text entry field in the login form receives cursor focus, the web browser software automatically calls the Javascript method specified in the onFocus property. In the this case, the “doSafeKey(this)” method is called, including an argument (“this”) which is a reference to the text entry field that obtained the cursor focus. The onFocus method itself as described previously, simply stores a reference to this text entry field in a global Javascript variable, so that other Javascript methods of the process module can access the active text entry field.

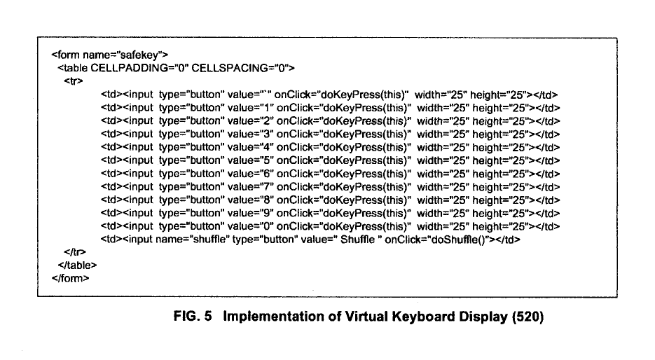

A process module (260) also contains a function (266) to detect the virtual key character selection on a graphical keyboard display module (201). In a preferred embodiment, this method is implemented with Javascript code. Referring to FIG. 4, which lists sample Javascript code of a graphical keyboard process module in a preferred embodiment, this method is named “doKeypress()”. A reference to this Javascript method (doKeyPress) is inserted as the “onClick” event handler in the declaration of each HTML button that comprises a virtual key (205) of the display module (201). FIG. 5 shows an example of how this declaration is constructed, and further reveals that an argument (“this”) is passed to the Javascript method. This argument represents the HTML button element (virtual key) of the declaration. When one of the virtual keys is selected by a user via a pointing device, the onClick event handler method “doKeyPress(this)” is automatically invoked by the web browser, and the selected HTML button element (virtual key) is passed to the doKeyPress() method. Finally, the virtual key character is determined by referencing the “value” field of the HTML button element, which, by virtue of how it was declared, always contains the virtual key character itself.

A process module (260) also contains a function (264) to distribute virtual key characters randomly to the virtual keys of a display module. The purpose of this function is to increase the security of the system by making it more difficult for keyloggers to guess user input by analyzing mouse clicks. The user can initiate this function at any time by selecting the “SHUFFLE” virtual function key on the graphical keyboard display module. A process module in a preferred embodiment accomplishes this task with Javscript code that randomly assigns a virtual key character to the “value” property of an HTML button comprising the virtual key.

A process module (260) also contains a function (270) to submit a web form to a web server. This is provided as a convenience, since all web forms by definition must have a submit button. In a preferred embodiment, a process module uses Javascript to invoke the submit( ) method of the HTML form object to accomplish this. This is initiated by a user by selecting the “SUBMIT” virtual function key on a graphical keyboard display module.

A process module (260) also contains a function (262) to render a virtual keyboard display module on the web browser. This may be rendered within the context of a web page or in a new window floating above a web page. In a preferred embodiment, this function is automatically accomplished by embedding the HTML and Javascript code of a graphical keyboard within the body of a web page, causing the web browser to display the graphical keyboard display module by default. In another embodiment, where the graphical keyboard process module is built-in to the code of a web browser, this function first analyzes the contents of a web page, and if a web form is discovered, it will then display the virtual keyboard, typically in a floating window not obscuring the web form.

OTHER EMBODIMENTS

While the preferred embodiment is designed to protect password entry on web login pages, the present invention is not limited to such application alone. Those skilled in the art will recognize that the present invention may be applied wherever a secure method of entering text in a web form is desirable. Examples of such applications include Internet shopping sites that require credit card numbers and other personal information to be entered into a web form before a purchase is completed; and web-based email services which may incorporate the present invention to protect the entry of text messages in web mail forms.

It will be apparent to one skilled in the art, that a graphical keyboard module (200) need not be implemented with Javascript code and an HTML form object as described in the preferred embodiment. For example, in another embodiment of the invention, a graphical keyboard module (200) is implemented as a browser plugin, written in C++ programming language. Still another embodiment of the present invention implements a graphical keyboard module (200) using a java applet along with Javascript code. In yet another embodiment, a graphical keyboard module (200) is implemented in C++ code which is built-in to the web browser software itself In general terms, a graphical keyboard module (200) can be implemented using any technique that allows it to be made available to a web client automatically, as part of a web page which contains a web form, and that enables it to read and modify text-entry fields contained in said web form. Being automatically available does not require that a graphical keyboard display module (201) be automatically displayed when a web page is rendered by a web browser. For instance, in one embodiment of the invention, a graphical keyboard display module (201) is initially hidden, and only made visible when a user selects a link (“graphical keyboard enabling region”) displayed on a web login page (100); alternatively, a display module (201) is made visible when a user presses a combination of keys (hotkey) on the hardware keyboard.

In view of the many possible embodiments to which the principles of this invention may be applied, it should be recognized that the preferred embodiment described herein is meant to be illustrative only and should not be taken as limiting the scope of this invention. For instance, those skilled in the art will recognize that the system is not limited to web login forms specifically, but may be applied to any web form, or any web application where secure text-entry is desirable. Therefore, the invention as described herein contemplates all such embodiments as may come within the scope of the following claims and equivalents thereof

What I claim as my invention is:

1. A method including the steps of,
presenting a web page from a web server to a web client, said web page including a web form containing one or more text-input fields; and
presenting a graphical keyboard at said web client in association with said web form; and
accepting user-selections from said graphical keyboard via a pointing device and converting said user selections to text characters using a transformation function; and
relaying said text characters to a selected one of said text-input fields in said web form; and
transmitting values of said text-input fields to said web server.

2. A method as in claim 1, wherein said text characters are relayed to a text-input field containing the active text cursor of said web form

3. A method as in claim 1, wherein said graphical keyboard is contained inside said web page, and displayed on a visible region of said web page

4. A method as in claim 1, wherein said graphical keyboard is contained in a visible graphical window separate of said web page

5. A method as in claim 1, wherein said graphical keyboard is disposed to render multiple user-selectable areas (“virtual keys”) each of said virtual keys displaying a symbol (“virtual key character”)

6. A method as in claim 5, wherein said virtual keys are rendered on said graphical keyboard in a manner resembling a layout of keys on a hardware keyboard

7. A method as in claim 5, wherein said virtual keys are randomly positioned on said graphical keyboard in a manner not resembling the position of corresponding keys on a hardware keyboard

8 A method as in claim 5, wherein said transformation function, is a direct mapping of said virtual key character displayed to a text encoding representing said virtual key character in an operating system character set.

9 A method as in claim 5, wherein said transformation function, is a parametric function mapping said virtual key character to a text encoding representing a different character in an operating system character set

10 A method as in claim 9, wherein parameters to said transformation function are provided by a user, via an initial selection of a sequence of said virtual keys

11. A method as in claim 1, wherein said web server is configured to provide the mechanism for displaying said graphical keyboard via code embedded within said web page or delivered as part of said web page

12. A method as in claim 1, wherein said web client is configured to provide the mechanism for displaying said graphical keyboard, via executable instructions residing in a browser mechanism used to render said web page

13. A method as in claim 1, wherein said graphical keyboard is initially hidden when said web page is delivered to said web client, and is made visible after a user-initiated action

14. A method as in claim 13, wherein said user-initiated action includes a user pressing a sequence of keys on the hardware keyboard

15. A method as in claim 13, wherein said user initiated action includes a user selecting a “graphical keyboard enabling” region on said web page, via a pointing device

16. A method as in claim 4, wherein said window containing said graphical keyboard is automatically hidden after said web form values are transmitted to said web server

17. A system, including:
A browser mechanism configured to present a web page from a web server to a web client, said web page including a web form with one or more text-input fields;
a graphical keyboard generation mechanism at said browser mechanism, configured to display a graphical keyboard in association with said web form;
a graphical keyboard mechanism configured to accept user selections via a pointing device, and to convert said user selections via a transformation function to text characters, and to automatically relay said text characters to a selected one of said text-input fields in said web form
a networking mechanism configured to transmit said web page from said web server to said web client, and to transmit values of said text-input fields from said web client to said web server

18. A system as in claim 17, wherein said web server is configured to deliver said graphical keyboard generation mechanism to said browser mechanism as part of said method of delivering said web page to said web client

19. A system as in claim 17, wherein said graphical keyboard generation mechanism is embedded in the logic and executable instructions of said browser mechanism

20. A system as in claim 17, wherein said web form is further comprised of other types of input fields in addition to said text-input fields

21. A system as in claim 17, wherein said web form is comprised of HTML form elements

22. A system as in claim 17, wherein said web form is comprised of Java components or ActiveX components, or other types of components capable of displaying text-entry fields in a web page and submitting values of said text-entry fields to said web server.

23. A system as in claim 22, wherein said graphical keyboard generation mechanism is configured to automatically generate and display said graphical keyboard in response to said browser mechanism displaying a web form in said web page

24. A system as in claim 17, further including a mechanism to initialize said transformation function with parameters supplied by a user
